(19) United States
(12) Patent Application Publication
(10) Pub. No.: US 2004/0043183 A1
(43) Pub. Date: Mar. 4, 2004

(54) Coordinating flooring and methods

(76) Inventors: Randell H. Thrasher, Birmingham, AL (US); Robert Lee Burch III, LaGrange, GA (US)

Correspondence Address: Daniel R. Alexander, Legal Department, M-495, PO Box 1926, Spartanburg, SC, 29304, US

(21) Appl. No.: 10/465,007

(22) Filed: Jun. 19, 2003

Related U.S. Application Data
(60) Provisional application No. 60/391,317, filed on Jun. 25, 2002.

(51) Int. Cl. B32B 3/02; B32B 3/14; B32B 33/00

(52) U.S. Cl. 428/85; 428/86; 428/77; 428/78; 428/79

(57) ABSTRACT

A multi-component color coordinated floor covering system including a carpet and a coordinated area rug, bath mat or other localized floor covering element. The carpet and the localized floor covering element include colored user contact surfaces. The colored user contact surface of the localized floor covering element includes at least one preselected color identical to at least one color in the user contact surface of the carpet. A related method is also provided.

### CROSS-REFERENCE TO RELATED APPLICATIONS

This application claims priority from and the benefit of United States provisional patent application 60/391,317 filed Jun. 25, 2002, the contents of which are incorporated by reference herein in their entirety as if fully set forth herein.

### FIELD OF THE INVENTION

The present invention relates to textile substrates, constructions, rugs, colors, designs, and/or patterns as well as systems, methods, processes, and/or techniques utilizing such constructions, rugs, colors, designs, and/or patterns. More particularly, the present invention relates to coordinating rugs and/or mats, such as area rugs and bath mats which coordinate, match or contrast with flooring such as commercial or hospitality carpet tile, broadloom, or the like. For example, the coordinating area rug or bath mat may have the same color, pattern, border pattern, and/or the like in common with or coordinating with the carpet tile or broadloom of the room or hallway.

### BACKGROUND

Textile floor covering materials are generally well known. Such floor coverings include constructions such as broadloom carpeting and carpet tile adapted to be held at a fixed position across a flooring surface. In this regard, it is to be understood that broadloom and carpet tiles serve substantially the same function of covering significant flooring areas. Broadloom carpeting provides such coverage using carpet constructions of extended length and width which are seamed, stretched and tacked in place across the floor. Carpet tile constructions utilize a coordinated arrangement of discrete tile elements placed across the floor so as to mimic the appearance of broadloom carpeting. By way of example only, and not limitation, carpet tiles are described in U.S. Pat. Nos. 4,522,857 and 6,203,881, each hereby incorporated by reference herein. While carpet tiles may be removable if desired, they are adapted to remain substantially in position at a fixed location across the flooring surface due to the presence of abutting surrounding tiles. Known floor coverings also include localized coverage constructions such as area rugs and bath mats which are adapted to be placed in a so called “free lay” arrangement across localized portions of a flooring surface and which may be freely removed and repositioned across a flooring surface.

In the past, broadloom carpet and carpet tile constructions adapted to cover expansive surface areas were considered as substantially distinct products from area rugs, bath mats and other localized coverage constructions. Users were generally considered to desire either carpeting (broadloom or carpet tile) or to desire localized coverage. Thus, these distinct product lines were typically designed independently from one another. Consequently, in the event that a user had a desire to coordinate the use of broadloom or carpet tile at one location with an area rug or bath mat at another location, a substantial amount of skill was required to identify patterns and/or color schemes from the diverse product lines which were in harmony and provided a desired aesthetic appearance. Inappropriate mixing of patterns and/or color schemes was substantially undesirable due to the high cost of replacing one or the other of floor covering patterns until a suitable arrangement was realized.

Recent advancements in the dyeing and printing of pile fabrics have permitted the development of a wide array of solid colors and complex patterns which may be applied to carpeting as well as to area rugs and other localized coverage constructions. For example, highly versatile jet dyeing of pile fabrics has been disclosed in U.S. Pat. Nos. 4,116,626, 5,136,520, 5,142,481, and 5,208,592, each of which are hereby incorporated by reference herein.

### SUMMARY

In accordance with at least a preferred embodiment of the present invention, textile products, substrates, constructions, rugs, mats, or the like may be produced with predefined coordinated color or patterning by printing or dyeing selected colors, designs, and/or patterns on a textile substrate such as carpet, for example tufted, bonded, looped, or cut pile carpet and/or area rug and/or bath mat. More preferably, the textile floor covering is jet dyed using a jet dye machine such as a Millitron® jet dye machine marketed by Milliken & Company of LaGrange, Ga. or the like.

Although it is preferred that the colors, patterns, designs and/or the like be produced by printing or dyeing such as rotary printing or screen printing, it is also known to produce such colors, patterns, and/or designs using colored yarns, tufting techniques, such as graphic tufting or hand tufting, painting, weaving, and the like.

Although the present invention is not limited to a particular substrate, examples of substrates useable in accordance with the present invention include cut or loop pile tufted, bonded, flocked, needled, or nonwoven substrates, such as cut pile tufted carpet, loop pile tufted carpet, and cut pile bonded carpet. The tufts or face yarn of such carpets may be of natural and/or synthetic fibers or materials, for example nylon and/or wool. More particularly, it is preferred to use 100% nylon 6,6 yarn, 100% nylon 6 yarn, or a blend of about 80% wool and 20% nylon yarn.

In accordance with the present invention designs, patterns, colors, and/or the like used within a commercial, institutional, hospitality, residential, or other flooring such as rooms carpet, hallway carpet, carpet tile, or the like are used to create washable or nonwashable coordinating, matching, or complementing rugs or mats, such as area rugs or bath mats. For example, one may coordinate bath or dressing areas, vanities, service bars, bars, adjacent rooms, bath area, balcony, foyer, entry areas, or the like to the room carpet or hallway carpet, or the like whether it be broadloom or carpet tile.

The present invention provides for more design flexibility within a project and provides advantages not previously offered. For instance, the present invention provides for not only coordinating hallway and rooms carpet, but also area rugs, bath mats, throw rugs, runners, inlays, floor mats, or the like which would coordinate with hallway and/or rooms carpet.

The present invention provides the market with another level of design coordination between rooms and public areas that can be used to improve the image and marketability of a property. The present invention thus provides a totally coordinated design package.

Also, the present invention provides advantages in that the coordinating, matching, or complementing rugs or mats may be washable, may be of various sizes and shapes, may have different finishes, edge treatments, backings, and the like. Also, the coordinating rugs or mats may be piece dyed rather than jet dyed.

Also, the coordinating rugs or mats may include bleach resistant technology, anti-bacterial protection, non-skid backing, cushion backing, piece dye capability, carved or sculpted face, colors with carving, jet dyeing, printing, and/or the like.

### BRIEF DESCRIPTION OF THE DRAWINGS

The present invention will now be described by way of example only, with reference to the accompanying drawings which constitute a portion of the specification herein and in which:

FIG. 1A is a schematic top view representation of a room or hallway carpet such as broadloom, tufted carpet, carpet tile, or the like, with a particular color thereon indicated by cross hatching;

FIG. 1B is a top view representation of an area rug having the same particular color as the room carpet of FIG. 1A;

FIG. 1C is a top view representation of a bath mat having the same particular color as the room carpet of FIG. 1A;

FIGS. 2A-2C are similar to those of FIGS 1A-1C except that the room carpet, area rug and bath math each have a particular pattern or design thereon;

FIG. 3A is similar to FIG. 2A except that the room or hallway carpet has a particular pattern thereon along with particular pattern and background colors;

FIG. 3B is a top view representation of an area rug having a color that matches with the background color of the room carpet of FIG. 3A;

FIG. 3C is a top view representation of a bath mat having a particular color which matches with the pattern color of the room carpet of FIG. 3A;

FIG. 4A is a schematic top view representation of a hallway or room carpet having pattern border areas and a solid or heather center field;

FIG. 4B is a top view representation of an area rug having a pattern matching to the border pattern of FIG. 4A;

FIG. 4C is a top view representation of a bath mat having the same color as the background color or center field of the hallway carpet of FIG. 4A;

FIG. 5A is a top view representation of a patterned room or hallway carpet;

FIG. 5B is a top view representation of an area rug having a border or frame having the same pattern as that of the room carpet of FIG. 5A;

FIG. 5C is a top view representation of a bath mat having a border or frame pattern matching the pattern of the room carpet of FIG. 5A;

FIG. 6A, like FIG. 5A, is a top view representation of a patterned room carpet or hallway carpet; and

FIGS. 6B and 6C are top view representations of respective area rugs and bath mats having a pattern which is similar to the pattern of the room carpet of FIG. 6A but which is created by carving or sculpting the pattern into the surface of the area rug and the bath mat rather than dyeing or printing the particular pattern of FIG. 6A thereon. This allows for the area rug and bath mat of FIG. 6B and 6C to be piece dyed a solid color while still having a sculpted or carved pattern which relates to the pattern of the room or hallway carpet.

While the invention has been described in connection with the embodiments discussed above, it is not intended to limit the scope of the invention to the particular form set forth, but on the contrary it is intended to cover such alternatives, modifications, and equivalents as may be included within the spirit and scope of the invention.

### DETAILED DESCRIPTION

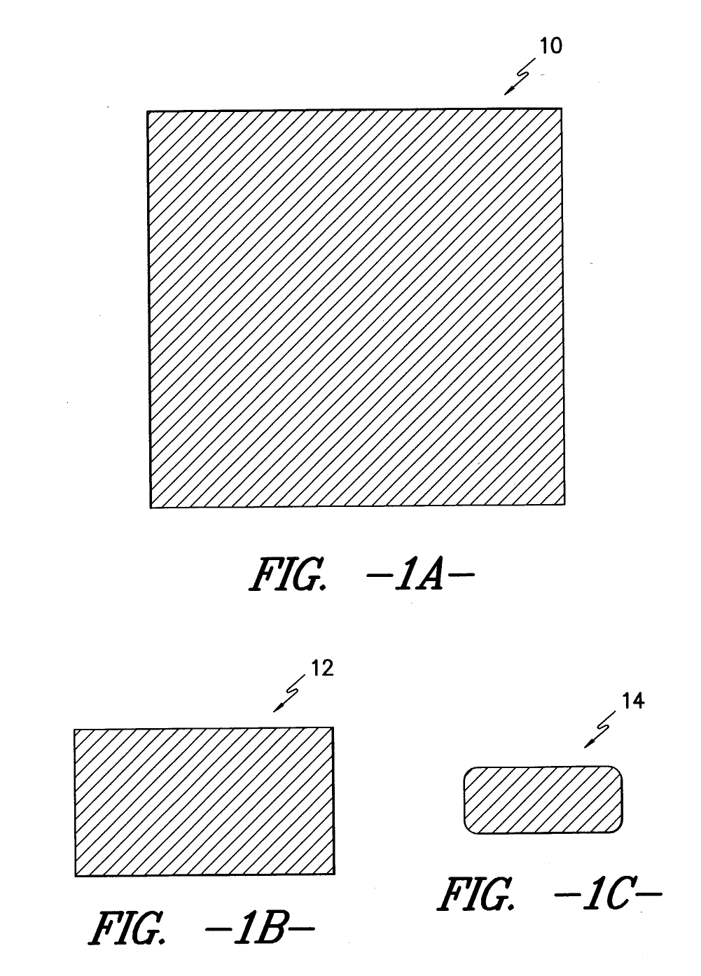

Reference will now be made to the figures, wherein to the extent possible, like elements are designated by like reference numerals throughout the various views. Turning now to FIGS 1A-1C, in FIG. 1A is a schematic representation of a flooring such as carpet, tile, laminate, or hardwood 10 preferably a broadloom carpet and/or carpet tiles arranged in edge to edge relation for disposition in wall to wall relation across an expansive flooring surface such as a room, hallway or the like. FIG. 1B is a schematic representation of an area rug 12 having a construction and dimensions such that it may be placed at a localized position across a flooring surface of larger dimensions. Likewise, FIG. 1C is a schematic representation of a bath mat 14 adapted to be placed at a localized position for the capture of moisture in a bathroom environment. The carpet 10, area rug 12 and bath mat 14 each include a pile face formed from a multiplicity of outwardly projecting pile elements defining an exterior show surface for contact by a user.

As illustrated by the cross-hatching, according to one contemplated practice the carpet 10, area rug 12 and bath mat 14 may all be of substantially identical solid coloration. Thus, the carpet 10, area rug 12 and bath mat 14 will be matched and will cooperatively define a coordinated floor covering system. Of course, it is to be understood that while such a coordinated system may include one or more area rugs 12 and/or one or more bath mats 14, in combination with carpet 10, it is also contemplated that any one of the elements can be eliminated if desired such that combinations of any two of the elements are utilized. That is, the system may be made up of carpet 10 and one or more area rugs 12 as well as carpet and one or more bath mats 14. It is also contemplated that the carpet 10 may be eliminated entirely such that the system is made up of one or more area rugs in combination with one or more bath mats. Also, it is contemplated that the elements 12 and 14 may be area rugs, bath mats, runners, throw rugs, inlays, floor mats, or the like. By way of example only, and not limitation, it is contemplated that substantial identity of coloration among the components may be achieved by use of jet dyeing such by use of a Millitron® jet dye machine from Milliken & Company having a place of business at LaGrange, Ga.

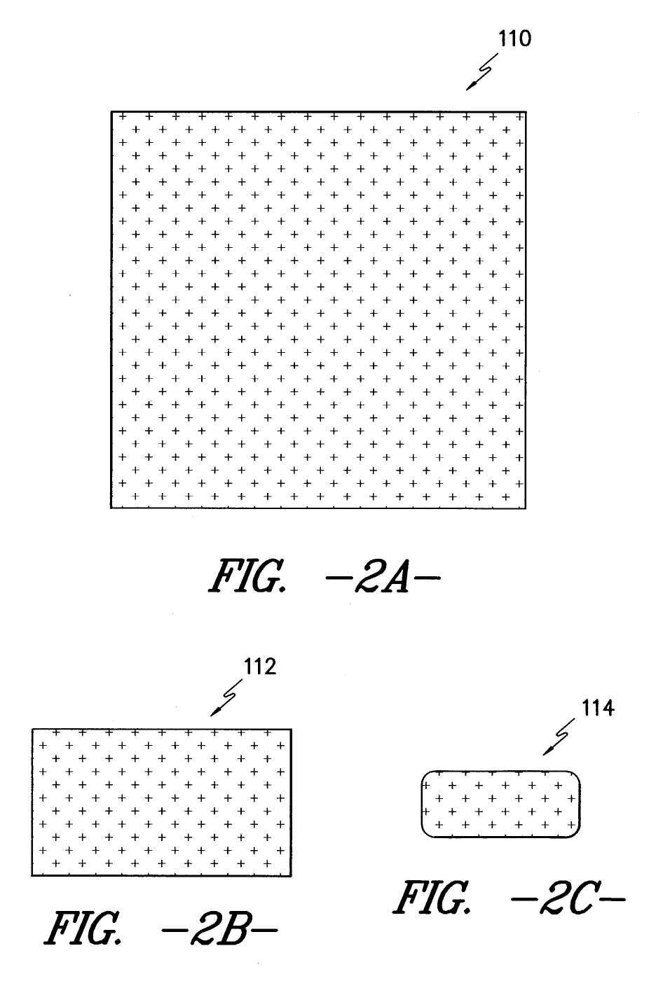

The present invention is also applicable to floor covering systems which utilize elements with patterned color schemes. By way of example only, the components of a patterned floor covering system are illustrated schematically in FIGS. 2A-2C in which elements corresponding to those previously described are designated by like reference numerals increased by 100. As illustrated, in the exemplary system the carpet 110, area rug 112 and bath mat 114 are each provided with a substantially identical surface pattern. Thus, these elements will define a coordinated design system. As will be appreciated, the relative size of the pattern elements on each of the components may be adjusted as desired. Thus, the pattern elements such as illustrations of flora, geometric designs and the like on the carpet 110 may be larger or smaller than the corresponding pattern elements on the area rug 112 and/or the bath mat 114. Likewise, the pattern elements on the area rug 112 may be larger or smaller than the corresponding pattern elements on the bath mat 114. Of course, it is also contemplated that the pattern elements may be identically sized on all components.

It is to be understood that while such a coordinated patterned floor covering system may include one or more area rugs 112 and/or one or more bath mats 114 in combination with carpet 110, it is also contemplated that any one of the elements can be eliminated if desired such that combinations of any two of the elements are utilized. That is, the system may be made up of carpet 110 and one or more area rugs 112 as well as carpet 110 and one or more bath mats 114. It is also contemplated that the carpet 110 may be eliminated entirely such that the system is made up of one or more area rugs 112 in combination with one or more bath mats 114.

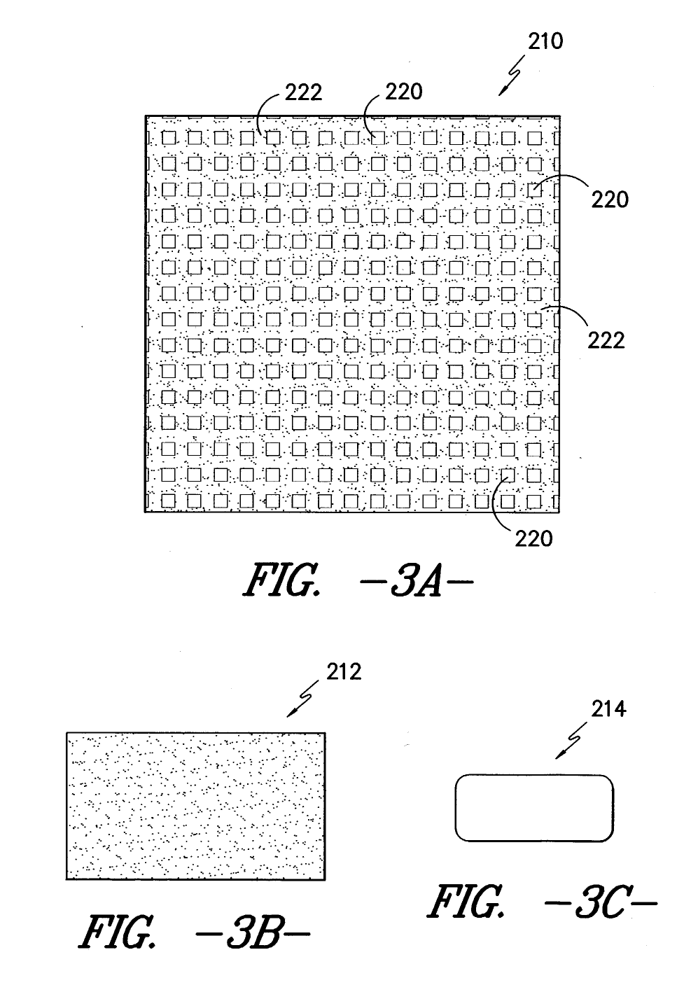

The present invention is also applicable to coordinated arrangements of patterned floor covering elements in combination with solid color flooring elements which match particular colors within the patterned floor covering. By way of example only, such a system is illustrated schematically in FIGS. 3A-3C in which elements corresponding to those previously described are designated by like reference numerals within a 200 series. As shown, in the exemplary system the room carpet 210 includes a multi-zone pattern formed from a multiplicity of pattern element zones 220 arranged with interstitial zones 222 of coloration different from the pattern element zones 220 such that the interstitial zones 222 define a background for the pattern. In the illustrated system the area rug 212 is colored to substantially match the interstitial zones 222. The bath mat is colored with a color corresponding to a color from the pattern element zones 220. In this regard it is to be understood that the pattern element zones 220 may incorporate a multiplicity of colors in which case one of those colors is used on the bath mat 214.

Of course, it is to be understood that the illustrated arrangement is exemplary only. In this regard it is to be understood that the coloration of the area rug 212 and the bath mat 214 may be reversed if desired. It is also contemplated that the area rug 212 and the bath mat may be of the same color as one another. In such an arrangement this common color may be selected either from the pattern element zones 220 or from the interstitial zones 222. It is also contemplated that the multi-zone pattern may reside on the area rug 212 or on the bath mat 214 as well as on the carpet 210. It is also contemplated that the multi-zone pattern may reside on the area rug 212 and/or the bath mat 214 with the carpet 210 being a solid color matching a color from one of the zones in the multi-zone pattern.

As with previous embodiments, the coordinated floor covering system which utilizes a patterned unit in combination with one or more solid color units may include one or more area rugs 212 and/or one or more bath mats 214 in combination with carpet 210, it is also contemplated that any one of the elements can be eliminated if desired such that combinations of any two of the elements are utilized. That is, the system may be made up of carpet 210 and one or more area rugs 212 as well as carpet 210 and one or more bath mats 214. It is also contemplated that the carpet 210 may be eliminated entirely such that the system is made up of one or more area rugs 212 in combination with one or more bath mats 214.

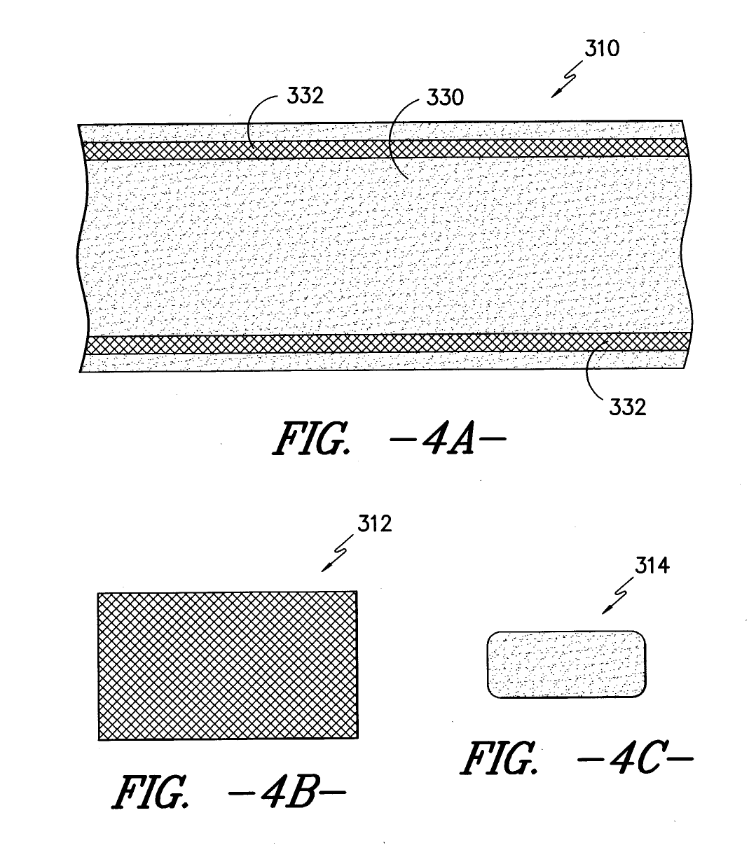

The present invention is also applicable to coordinated arrangements of border patterned floor covering elements including central field zones and outboard border pattern zones in combination with complementary flooring elements at least a portion of which are colored to match the central field zones or border pattern zones. By way of example only, such a system is illustrated schematically in FIGS. 4A-4C in which elements corresponding to those previously described are designated by like reference numerals within a 300 series. As shown, in the exemplary system the carpet 310 includes a multi-zone pattern formed from a central field zone 330 (which may be either patterned or unpatterned) bounded by border zones 332 of different coloration 10 and/or patterning from the central field zone. The exemplary system further includes an area rug 312 colored to match the border zones 332 and a bath mat 314 colored to match the central field zone 330.

Of course, it is to be understood that the illustrated arrangement is exemplary only. In this regard it is to be understood that the coloration of the area rug 312 and the bath mat 314 may be reversed if desired. It is also contemplated that the area rug 312 and the bath mat 314 may be of the same color or pattern as one another. In such an arrangement this common color or pattern may be selected either from the central field zone 332 or from the border zones 332. It is also contemplated that the overall central field zone in combination with the border zones may reside on the area rug 312 or the bath mat 314 as well as on the carpet 310.

As with previous embodiments, the coordinated floor covering system which utilizes a bordered pattern unit in combination with one or more floor covering units matching colors or patterns from the bordered pattern unit may include one or more area rugs 312 and/or one or more bath mats 314 in combination with carpet 310. It is also contemplated that any one of the elements can be eliminated if desired such that combinations of any two of the elements are utilized. That is, the system may be made up of carpet 310 and one or more area rugs 312 as well as carpet 310 and one or more bath mats 314. It is also contemplated that the carpet 310 may be eliminated entirely such that the system is made up of one or more area rugs 312 in combination with one or more bath mats 314.

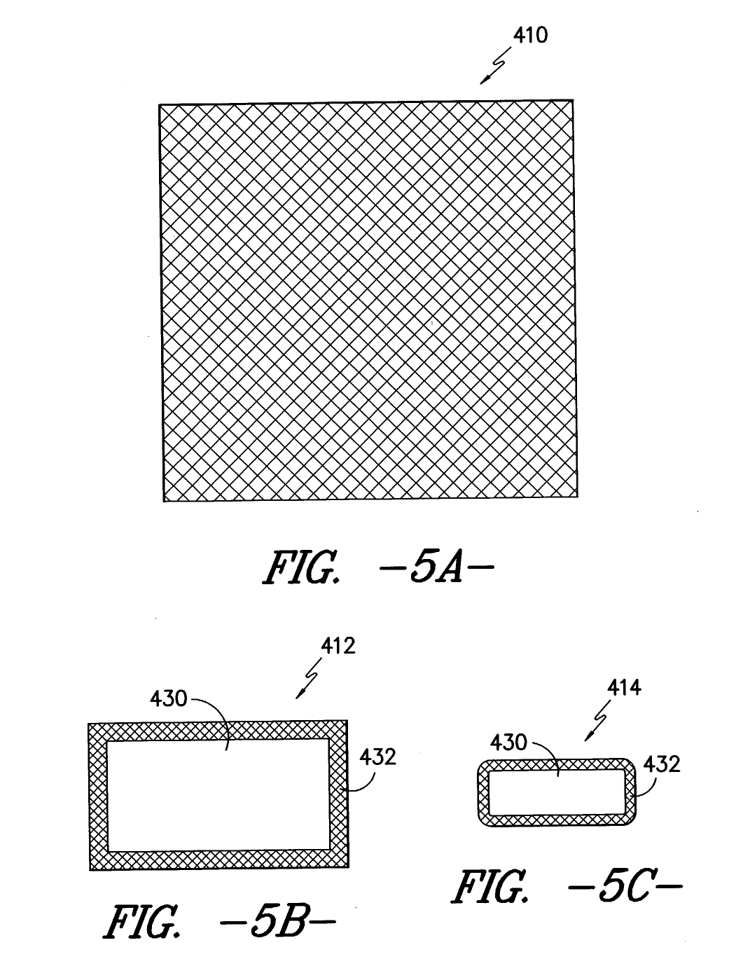

Still a further contemplated system is illustrated in FIGS. 5A-5C wherein elements corresponding to those previously described are designated by like reference numerals within a 400 series. In this exemplary system, a framed pattern made up of a central field zone 430 framed by border zones 432 may reside on the area rug 412 and/or on the bath mat 414 with the carpet 410 being a solid color or pattern matching a solid color or pattern in the central field zone 430 or border zones 432.

As with previous embodiments, the coordinated floor covering system which utilizes a frame pattern area rug 412 and/or bath mat 414 in combination with a carpet 410 matching colors or patterns from the frame pattern unit may include one or more area rugs 412 and/or one or more bath mats 414 in combination with carpet 410. It is also contemplated that any one of the elements can be eliminated if desired such that combinations of any two of the elements are utilized. That is, the system may be made up of carpet 410 and one or more area rugs 412 as well as carpet 410 and one or more bath mats 414. It is also contemplated that the carpet 410 may be eliminated entirely such that the system is made up of one or more area rugs 412 in combination with one or more bath mats 414.

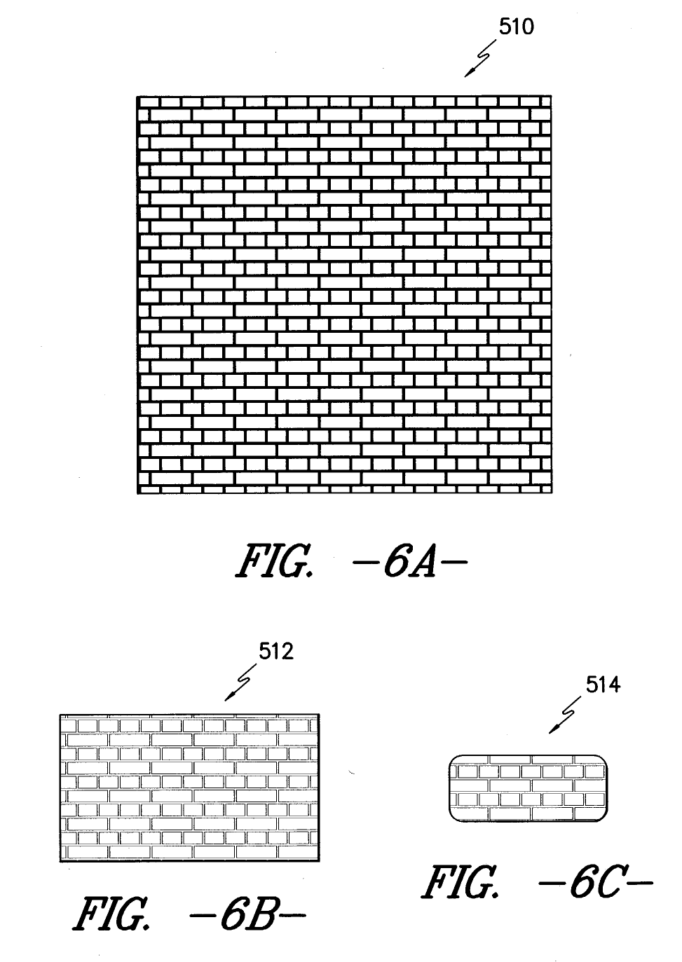

In accordance with the present invention, it is also contemplated that a floor covering system may be provided in which patterned printed carpet is utilized in combination with one or more area rugs or bath mats having sculpted patterns corresponding to the printed patterns on the carpet. One such exemplary system is utilized in FIGS. 6A-6C wherein elements corresponding to those previously described are designated by like reference numerals in a 500 series.

In the exemplary system illustrated in FIGS. 6A-6C, the carpet 510 includes a printed surface pattern such as may be applied by a jet dye apparatus such as a Millitron® jet dye machine or the like. Conversely, the area rug 512 and/or bath mat 514 are piece dyed a solid color. However, it is contemplated that a pattern corresponding substantially to the pattern on the carpet 510 may nonetheless be imparted to the area rug and/or bath mat by sculpting such a pattern across the surface. As will be appreciated, such a pattern may be imparted by a number of techniques including high pressure fluid impingement, high temperature air impingement, acid etching, blade carving, and combinations of such practices.

Of course, it is also contemplated that the sculpting may be applied to the carpet 510 with corresponding printing taking place on the area rug 512 and/or bath mat 514. As with previous embodiments, the coordinated floor covering system which utilizes combinations of printed and sculpted floor covering elements may include one or more area rugs 512 and/or one or more bath mats 514 in combination with carpet 510. It is also contemplated that any one of the elements can be eliminated if desired such that combinations of any two of the elements are utilized. That is, the system may be made up of carpet 510 and one or more area rugs 512 as well as carpet 510 and one or more bath mats 514. It is also contemplated that the carpet 510 may be eliminated entirely such that the system is made up of one or more area rugs 512 in combination with one or more bath mats 514.

It has been found that the present invention finds special applicability in jet dyed products in that jet dyeing provides for the versatile production of area rugs, bath mats, or the like printed in broadloom form, cut to size, and then edge treated. In this regard it has been found that jet dyeing provides substantially for an unlimited array of colors, patterns, and/or designs so that area rugs and bath mats can be made to match, coordinate with, or complement any room carpet, hallway carpet, public space flooring, or the like.

It is to be understood that while the present invention has been illustrated and described in relation to potentially preferred embodiments, constructions and procedures, that such embodiments, constructions and procedures are illustrative only and that the present invention is in no event to be limited thereto. Rather, it is contemplated that modifications and variations embodying the principles of the present invention will no doubt occur to those of skill in the art. It is therefore contemplated and intended that the present invention shall extend to all such modifications and variations as may incorporate the broad aspects of the present invention within the full spirit and scope thereof.

1. A method of providing a multi-component color coordinated floor covering system, the method comprising:
providing at least a first floor covering adapted to provide wall to wall coverage over a first segment of flooring; and
providing at least one localized floor covering element selected from the group consisting of area rugs, bath mats, runners, throw rugs, inlays, and floor mats, wherein said floor covering elements are adapted to cover localized portions of at least a second segment of flooring, and wherein said first floor covering and said at least one localized floor covering element include colored user contact surfaces and wherein the colored user contact surface of said at least one localized floor covering element includes at least one color preselected to be identical to, coordinate with, or contrast to at least one color in the user contact surface of said first floor covering.

2. The method according to claim 1, wherein said first floor covering is selected from the group consisting of broadloom carpet and carpet tile.

3. The method according to claim 2, wherein said first floor covering and said at least one localized floor covering element are jet dyed.

4. The method according to claim 3, wherein the user contact surface of said first floor covering is a single solid color.

5. The method according to claim 3, wherein the user contact surface of said at least one localized floor covering element is a single solid color.

6. The method according to claim 3, wherein the user contact surface of said first floor covering and the user contact surface of said at least one localized floor covering element are each a single solid color.

7. The method according to claim 1, wherein said first floor covering has a multi-color pattern comprising a plurality of pattern elements disposed across the user contact surface.

8. The method according to claim 7, wherein said at least one localized floor covering element has a multi-color pattern comprising a plurality of pattern elements corresponding in a one to one relationship to the pattern elements disposed across the user contact surface of the first floor covering.

9. The method according to claim 8, wherein said first floor covering and said at least one localized floor covering element are jet dyed.

10. The method according to claim 7, wherein the user contact surface of said at least one localized floor covering element is a single solid color.

11. The method according to claim 1, wherein the user contact surface of said first floor covering includes an interior field and a border different from the interior field disposed outboard of the interior field, and wherein the user contact surface of said at least one localized floor covering element is substantially identical to one of the border or the interior field.

12. The method according to claim 11, wherein the user contact surface of said first floor covering and the user contact surface of said at least one localized floor covering element are each jet dyed.

13. The method according to claim 11, further comprising providing at least a second localized floor covering element selected from the group consisting of area rugs, bath mats, runners, throw rugs, inlays, and floor mats and said second localized floor covering element includes a user contact surface substantially identical to the other of the border or the interior field.

14. The method according to claim 13, wherein the user contact surface of said first floor covering and the user contact surface of said at least one localized floor covering element and the user contact surface of said second localized floor covering element are each jet dyed.

15. The method according to claim 1, wherein the user contact surface of said at least one localized floor covering element comprises an interior field and a border different from the interior field disposed in surrounding framing relation to the interior field, and wherein the user contact surface of said first floor covering is substantially identical to one of the border or the interior field.

16. The method according to claim 15, wherein the user contact surface of said first floor covering and the user contact surface of said at least one localized floor covering element are each jet dyed.

17. The method according to claim 1, wherein said carpet has a multi-color pattern comprising a plurality of pattern elements disposed across the user contact surface and wherein said at least one localized floor covering element has a sculpted pattern comprising a plurality of pattern elements corresponding in a one to one relationship to the pattern elements disposed across the user contact surface of the first floor covering.

18. A multi-component color coordinated floor covering system, the system comprising in combination:
a carpet adapted to provide wall to wall coverage over a first segment of flooring; and
at least one localized floor covering element selected from the group consisting of area rugs and bath mats, wherein said area rugs and said bath mats are adapted to cover localized portions of at least a second segment of flooring, and wherein said carpet and said at least one localized floor covering element include colored user contact surfaces and wherein the colored user contact surface of said at least one localized floor covering element includes at least one color preselected to be identical to at least one color in the user contact surface of said carpet.

19. The system according to claim 18, wherein said carpet is selected from the group consisting of broadloom carpet and carpet tile.

20. The system according to claim 19, wherein said carpet and said at least one localized floor covering element are jet dyed.

21. The system according to claim 20, wherein the user contact surface of said carpet is a single solid color.

22. The system according to claim 20, wherein the user contact surface of said at least one localized floor covering element is a single solid color.

23. The system according to claim 20, wherein the user contact surface of said carpet and the user contact surface of said at least one localized floor covering element are each a single solid color.

24. The system according to claim 18, wherein said carpet has a multi-color pattern comprising a plurality of pattern elements disposed across the user contact surface.

25. The system according to claim 24, wherein said at least one localized floor covering element has a multi-color pattern comprising a plurality of pattern elements corresponding in a one to one relationship to the pattern elements disposed across the user contact surface of the carpet.

26. The system according to claim 25, wherein said carpet and said at least one localized floor covering element are jet dyed.

27. The system according to claim 24, wherein the user contact surface of said at least one localized floor covering element is a single solid color.

28. The system according to claim 18, wherein the user contact surface of said carpet includes an interior field and a border different from the interior field disposed outboard of the interior field, and wherein the user contact surface of said at least one localized floor covering element is substantially identical to one of the border or the interior field.

29. The system according to claim 28, wherein the user contact surface of said carpet and the user contact surface of said at least one localized floor covering element are each jet dyed.

30. The system according to claim 28, further comprising at least a second localized floor covering element selected from the group consisting of area rugs and bath mats, wherein said second localized floor covering element includes a user contact surface substantially identical to the other of the border or the interior field.

31. The system according to claim 30, wherein the user contact surface of said carpet and the user contact surface of said at least one localized floor covering element and the user contact surface of said second localized floor covering element are each jet dyed.

32. The system according to claim 18, wherein the user contact surface of said at least one localized floor covering element comprises an interior field and a border different from the interior field disposed in surrounding framing relation to the interior field, and wherein the user contact surface of said carpet is substantially identical to one of the border or the interior field.

33. The system according to claim 32, wherein the user contact surface of said carpet and the user contact surface of said at least one localized floor covering element are each jet dyed.

34. The system according to claim 18, wherein said carpet has a multi-color pattern comprising a plurality of pattern elements disposed across the user contact surface and wherein said at least one localized floor covering element has a sculpted pattern comprising a plurality of pattern elements corresponding in a one to one relationship to the pattern elements disposed across the user contact surface of the carpet.
